(19) United States
(12) Patent Application Publication
(10) Pub. No.: US 2010/0183831 A1
(43) Pub. Date: Jul. 22, 2010

(54) Method of producing composite recycled bottle sheet products

(75) Inventor: Kenneth P. Glynn, Flemington, NJ (US)

Correspondence Address: Kenneth P. Glynn, 24 Mine Street, Flemington, NJ, 08822, US

(73) Assignee: B Green Innovations Inc.

(21) Appl. No.: 12/321,406

(22) Filed: Jan. 21, 2009

(51) Int. Cl. B32B 1/02; B29C 65/08; B29C 65/14; B06B 1/02; B32B 9/04; B32B 3/00

(52) U.S. Cl. 428/35.7; 264/248; 264/138; 264/442; 264/480; 428/411.1; 428/174

(57) ABSTRACT

A method of producing a composite recycled bottle sheet product, which includes: (a) providing a plurality of empty, cleaned, recycled plastic bottles; (b) stacking the bottles in a molding member having a predetermined width, the stacking having an uncompressed height of at least six inches; (c) compressing and heating the bottles to partially melt and fuse the bottles to create a compressed flat composite recycled bottle sheet so as to visibly display a plurality of deformed identifiable bottles; and, (d) creating a product from the compressed flat composite recycled bottle sheet so as to retain the visible display of the plurality of deformed identifiable bottles.

### BACKGROUND OF INVENTION

a. Field of Invention

The invention relates generally to a method of producing composite recycled bottle sheet products from recycled plastic bottles. The recycled plastic bottles are sterilized and are placed in a molding member for producing a composite recycled bottle composite sheet in batch or continuous manufacturing processing. Compression and heating of the bottles is accomplished to create the composite sheet. The heating is such that the bottles are slightly melted to deform and fuse the bottles so that original characteristics of the bottles remain visible, if somewhat obscurely, such as color, design, labels, and shape. The sheets are then used to create products that display the individual deformed bottles in a recognizable manner.

b. Description of Related Art

The following patents are representative of the field pertaining to the present invention:

U.S. Pat. No. 5,468,779 to Yamamoto et al. describes a plastic material with a paint film in coarse-crushed, and a film decomposition agent, e.g. a heterocyclic compound such as imidazolek, a triazine compound such as benoguanamine, a phenylendiamine compound such as N-phenyl-N-isopropyl-p-phenylene diamine, is added to the coarse-crushed material. The mixture is then heated and kneaded to dissolve the paint film and uniformly spread the particles of the paint film in the plastic material. The physical properties and surface quality of the plastic material are substantially the same as those of the original material.

U.S. Pat. No. 5,879,797 to Kim describes s novel matrix containing nephrite jade power as a main component. By using the matrix, a variety of goods in the field of medical goods, utensil goods, agricultural goods, industrial goods, fishery goods, traffic goods, transportation goods, equipment for sports, electronic instruments, precision instruments, pr the like ca be prepared. The goods made of the matrix can show excellent effects of treating pathological symptoms (headache, numb feeling, indigestion, insomnia, pr the like), removing impurities (such as heavy metals), improving the quality of water, promoting the growth of plants by virtue of the inherent properties of nephrite jade.

U.S. Patent Publication US 2008/00200221 A1 describes systems and methods of generating a recycled output. The recycled output may include a fabric produced by fusing reclaimed plastic bags. The reclaimed plastic bags are fused together using a material manufacturing system. The system is typically configured to heat the plastic bags to a temperature wherein the plastic bags fuse together but do not completely melt. Some embodiments include the addition of different types of plastic or non-plastic materials to the recycled output. Also disclosed are systems and methods of controlling texture and patterns within the recycled output.

U.S. Patent Publication US 2008/0145580 A1 discloses a recycled insulation material which includes plastic and/or rubber shredded or chopped up into individual pieces having random or semi-random sizes or semi-random air-pockets in between many of the individual pieces. The shredded or chopped up plastic and/or rubber pieces in combination with the air-pockets are configured to operate as an insulation filler for a variety of different panes, forms, pipes, conduits or any other item that requires insulation.

U.S. Patent Publication US 2008/02411455 A1 relates to an encapsulated member made with open molds for forming the exterior surface of the encapsulated member, wherein the encapsulation is accomplished with at least an outer skin configuration of a plastic, metal, ceramic or other moldable material for encapsulating pre-forms, reinforcements, sheeted materials, metallic pre-forms and other core materials that can be protected from the outer elements and manufacturing considerations. FIG. 3c shows and encapsulating reinforced member located within an open mold having skins thereon, and being filled in between with formable material.

Notwithstanding the prior art, the present invention is neither taught nor rendered obvious thereby.

### SUMMARY OF INVENTION

The present invention provides a method of producing a composite recycled bottle sheet product, which includes: (a) providing a plurality of empty, cleaned, recycled plastic bottles; (b) stacking the bottles in a molding member having a predetermined width, the stacking having an uncompressed height of at least six inches; (c) compressing and heating the bottles to partially melt and fuse the bottles to create a compressed flat composite recycled bottle sheet so as to visibly display a plurality of deformed identifiable bottles; and, (d) creating a product from the compressed flat composite recycled bottle sheet so as to retain the visible display of the plurality of deformed identifiable bottles.

In some preferred embodiments of the present invention method of producing a composite recycled bottle sheet product, step (d) includes a processing step selected from the group consisting of molding, casting, cutting, machining, and combinations thereof .

In some preferred embodiments of the present invention method of producing a composite recycled bottle sheet product, the heating is at a temperature of at least the lowest melting point of the bottles and exposure time is sufficient to deform, partially melt and fuse the bottles.

In some preferred embodiments of the present invention method of producing a composite recycled bottle sheet product, the stacking has a height of at least eight inches prior to compressing and heating.

In some preferred embodiments of the present invention method of producing a composite recycled bottle sheet product, the method is a continuous method.

In some preferred embodiments of the present invention method of producing a composite recycled bottle sheet product, the compressing is performed utilizing at least one compression roller.

In some preferred embodiments of the present invention method of producing a composite recycled bottle sheet product, the at least one compression roller is selected from the group consisting of a heated patterned compression roller, a cold patterned compression roller, a heated smooth compression roller, a cold smooth compression roller, and combinations thereof.

In some preferred embodiments of the present invention method of producing a composite recycled bottle sheet product, there is one compression roller and heating is performed at time intervals selected from the group consisting of before, during, or after compression.

In some preferred embodiments of the present invention method of producing a composite recycled bottle sheet product, there are two compression rollers and heating is performed at time intervals selected from the group consisting of before first roller compression, during first roller compression, after first roller compression, before second roller compression, during second roller compression, and after second roller compression.

In some preferred embodiments of the present invention method of producing a composite recycled bottle sheet product, the heating is performed utilizing a method selected from the group consisting of convection, induction, microwave, ultrasonic and infrared.

In some preferred embodiments of the present invention method of producing a composite recycled bottle sheet product, the stacking has a height of at least eight inches prior to compressing and heating.

In some preferred embodiments of the present invention method of producing a composite recycled bottle sheet product, the stacking has a height of at least eight inches prior to compressing and heating.

In some preferred embodiments of the present invention method of producing a composite recycled bottle sheet product, the heating is to a temperature sufficient to deform, partially melt and fuse the bottles.

In some preferred embodiments of the present invention method of producing a composite recycled bottle sheet product, the heating is at a temperature of at least the lowest melting point of the bottles and exposure time is sufficient to deform, partially melt and fuse the bottles.

In some preferred embodiments of the present invention method of producing a composite recycled bottle sheet product, the heating is performed utilizing a method selected from the group consisting of convection, induction, microwave, ultrasonic and infrared.

In some preferred embodiments of the present invention method of producing a composite recycled bottle sheet product, the compressed flat composite recycled bottle sheet product is fixed having a predetermined fixed length dimension.

In some preferred embodiments of the present invention method of producing a composite recycled bottle sheet product, the heating is performed utilizing a method selected from the group consisting of convection, induction, microwave, ultrasonic and infrared.

In some preferred embodiments of the present invention method of producing a composite recycled bottle sheet product, the stacking has a height of at least eight inches prior to compressing and heating.

In some preferred embodiments of the present invention method of producing a composite recycled bottle sheet product, the heating is to a temperature sufficient to deform, partially melt and fuse the bottles.

In some preferred embodiments of the present invention method of producing a composite recycled bottle sheet product, the heating is at a temperature of at least the lowest melting point of the bottles and exposure time is sufficient to deform, partially melt and fuse the bottles.

In some preferred embodiments, a product is produced by the method of paragraph [00009].

In some preferred embodiments, the product produced by the method of paragraph [00009] is selected from the group consisting of a container having a bottom and at least one sidewall selected from the group consisting of a waste basket, a tray, a planting pot, a dish and a bin.

In some preferred embodiments, the product produced by the method of paragraph [00009] is a flat product selected from the group consisting of a chair mat, a desk top mat, a table protector, a window panel, and a shelf.

In some preferred embodiments, the product produced by the method of paragraph [00009] includes at least one curved component.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detail description serve to explain the principles of the invention. In the drawings:

FIG. 1 is a schematic view of a method of producing a composite recycled bottle sheet product from recycled plastic bottles according to the present invention;

FIG. 2 is a schematic view of a method of producing a composite recycled bottle sheet product from recycled plastic bottles according to the present invention, illustrating a batch process and a continuous process;

FIG. 3 is a schematic view of a method of producing a composite recycled bottle sheet product from recycled plastic bottles according to the present invention, illustrating a two roller compression unit;

FIG. 4 is a schematic view of a method of producing a composite recycled bottle sheet product from recycled plastic bottles according to the present invention, illustrating processing steps for creating the product;

FIG. 5 is a schematic view of a method of producing a composite recycled bottle sheet product from recycled plastic bottles according to the present invention, illustrating heating;

FIG. 6 is a schematic view of a method of producing a composite recycled bottle sheet product from recycled plastic bottles according to the present invention, illustrating a products created;

FIG. 7 illustrates a top oblique view of a chair mat made by the method of the present invention;

FIG. 8 illustrates a side view of a waste basket made by the method of the present invention;

FIG. 9 illustrates a side oblique view of a plant pot made by the method of the present invention; and,

FIG. 10 illustrates a front view of a water cooler with a bottle made by the method of the present invention.

### DETAILED DESCRIPTION OF THE EMBODIMENTS

The present invention relates to a method of producing a composite recycled bottle sheet from recycled plastic bottles. The recycled plastic bottles are sterilized and are dumped into a molding member for producing a composite recycled bottle composite sheet in batch or continuous manufacturing processing.

Compression and heating of the bottles is accomplished to create the composite sheet. The heating is such that the bottles are slightly melted to deform and fuse the bottles. However, the original characteristics of the bottle remain visible, if somewhat obscurely, such as color, design, labels, and shape. The deforming may be such that one will recognize the original bottle. Thus, a Pepsi bottle will be distinguishable from a ginger ale bottle which will be distinguishable from a Coke bottle.

In some cases, labels may be removed from the bottles, but in other cases, they are not removed. Preferably paper labels are not kept. If labels are removed, they may be heat fused or melted. In some cases, the bottles may be chopped, in which case, the bottles may not be as easily identifiable.

When the composite sheet is made in batch, there are predefined dimensions for the composite sheet. A tray with a compressing means is used for the process. The compressing means may a plate, a cover or a press. When the composite sheet is continuous, compression is obtained by the use of at least one compression roller.

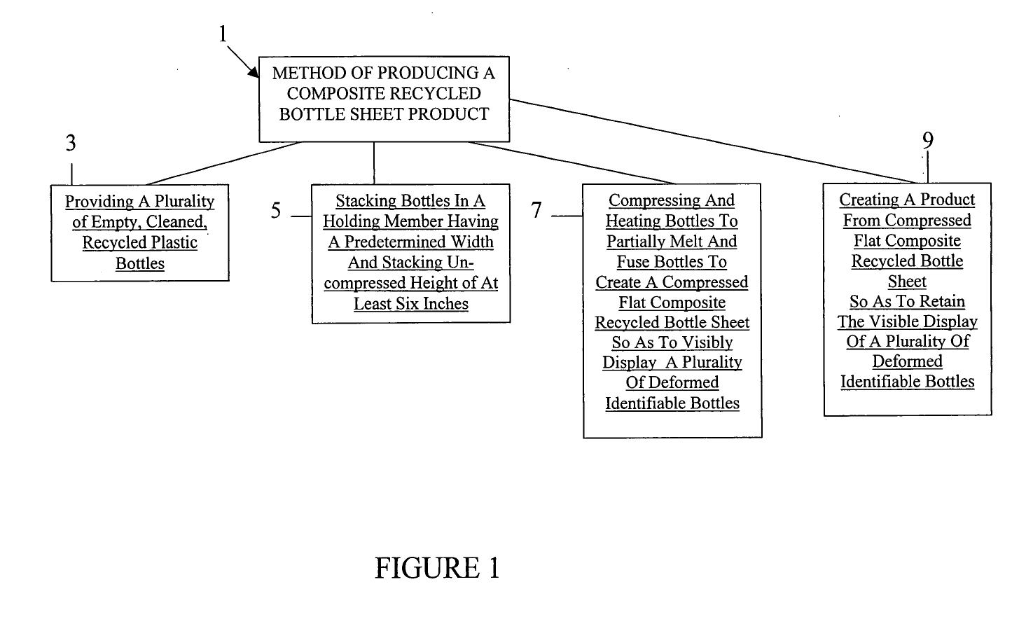

Referring now to the drawings wherein like reference numerals designate corresponding parts throughout the several views, FIG. 1 is a schematic view of a method of producing a composite recycled bottle sheet product from recycled plastic bottles 1 according to the present invention.

The method of producing a composite recycled bottle sheet 1 includes: (a) providing a plurality of empty, cleaned, recycled plastic bottles 3; (b) stacking the bottles in a molding member having a predetermined width, and the stacking having an uncompressed height of at least six inches 5; (c) compressing and heating the bottles to partially melt and fuse the bottles to create a compressed flat composite recycled bottle sheet so as to visibly display a plurality of deformed identifiable bottles 7; and, (d) creating a product from the compressed flat composite recycled bottle sheet so as to retain the visible display of the plurality of deformed identifiable bottles 9.

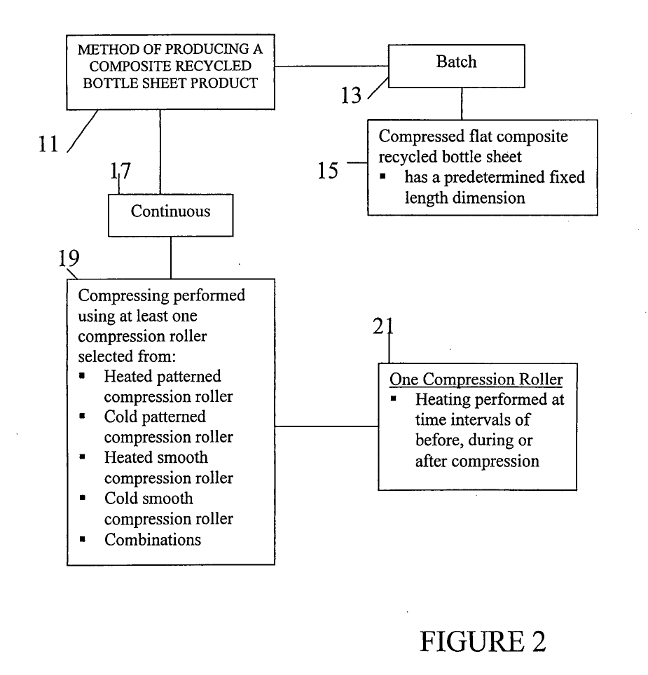

FIG. 2 is a schematic view of a method of producing a composite recycled bottle sheet product 11 from recycled plastic bottles according to the present invention, illustrating a batch process 13 and a continuous process 17.

With regard to the batch process 13, the compressed flat composite recycled bottle sheet has a predetermined fixed length dimension.

With regard to the continuous process 17, box 19 shows that compressing is performed utilizing at least one compression roller. Furthermore, the at least one compression roller is selected from the group consisting of a heated patterned compression roller, a cold patterned compression roller, a heated smooth compression roller, a cold smooth compression roller, and combinations thereof.

With regard to box 21, there is one compression roller and heating is performed at time intervals selected from the group consisting of before, during, or after compression.

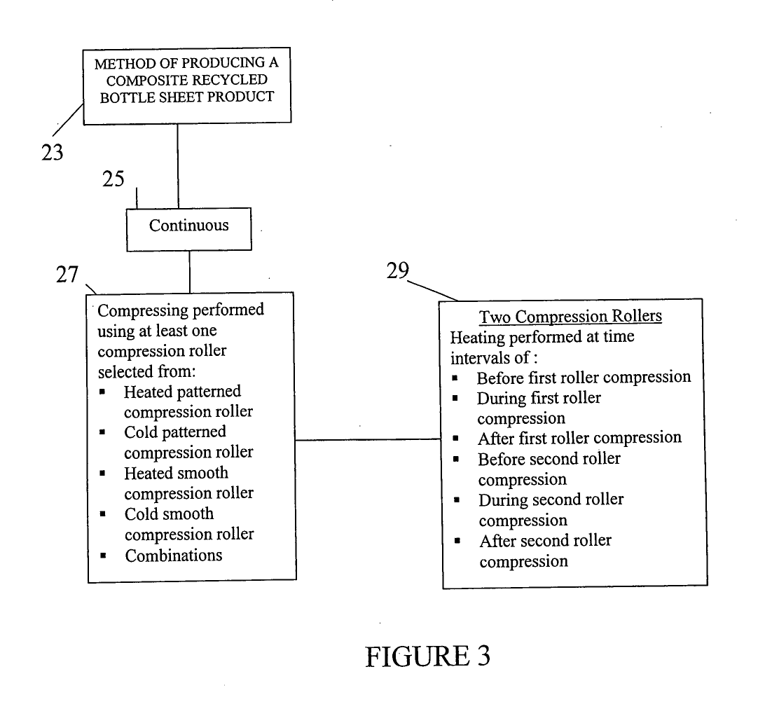

FIG. 3 is a schematic view of a method of producing a composite recycled bottle sheet product 23 from recycled plastic bottles according to the present invention, illustrating a two roller compression unit 29. With regard to the continuous process flowing from box 25, box 27 shows that compressing is performed utilizing at least one compression roller. Furthermore, the at least one compression roller is selected from the group consisting of a heated patterned compression roller, a cold patterned compression roller, a heated smooth compression roller, a cold smooth compression roller, and combinations thereof.

With regard to box 29, there are two compression rollers and heating is performed at time intervals selected from the group consisting of before first roller compression, during first roller compression, after first roller compression, before second roller compression, during second roller compression, and after second roller compression.

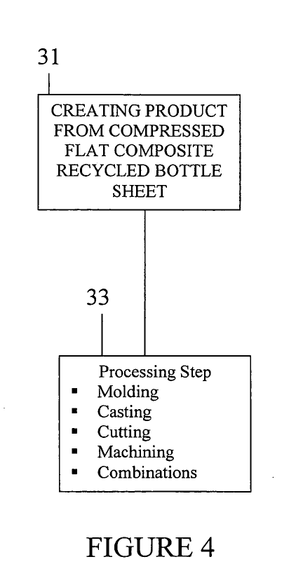

FIG. 4 is a schematic view of a method of producing a composite recycled bottle sheet product from recycled plastic bottles according to the present invention, illustrating processing steps for creating the product 31. With regard to box 33, creating the product from compressed flat composite recycled bottle sheets includes a processing step selected from molding, casting, cutting, machining and combinations thereof.

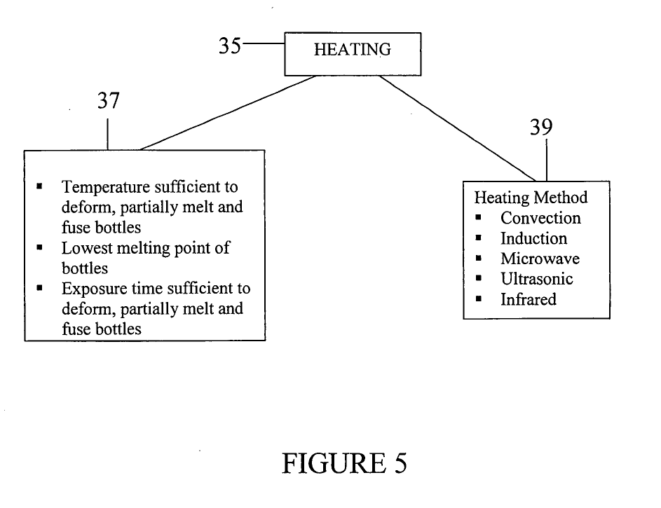

FIG. 5 is a schematic view of a method of producing a composite recycled bottle sheet product from recycled plastic bottles according to the present invention, illustrating heating 35. With regard to the box 37, the heating is to a temperature sufficient to deform, partially melt and fuse the bottles, the heating is at a temperature of at least the lowest melting point of the bottles and exposure time is sufficient to deform, partially melt and fuse the bottles. With regard to box 39, the heating is performed utilizing a method selected from the group consisting of convection, induction, microwave, ultrasonic and infrared.

FIG. 6 is a schematic view of a method of producing a composite recycled bottle sheet product from recycled plastic bottles according to the present invention, illustrating a products produced 41. With regard to box 43, the product consists of a container having a bottom and at least one sidewall, which includes a waste basket, a tray, a planting pot, a dish, a bin, and the like. These products may be circular.

With regard to box 45, the product is a flat product, which includes a chair mat, a desk top mat, a table protector, a window panel, a shelf, and the like. With regard to box 47, the product includes at least one curved component, which includes a clock cover, a cup, a water cooler bottle, a roof dome, a skylight, and the like.

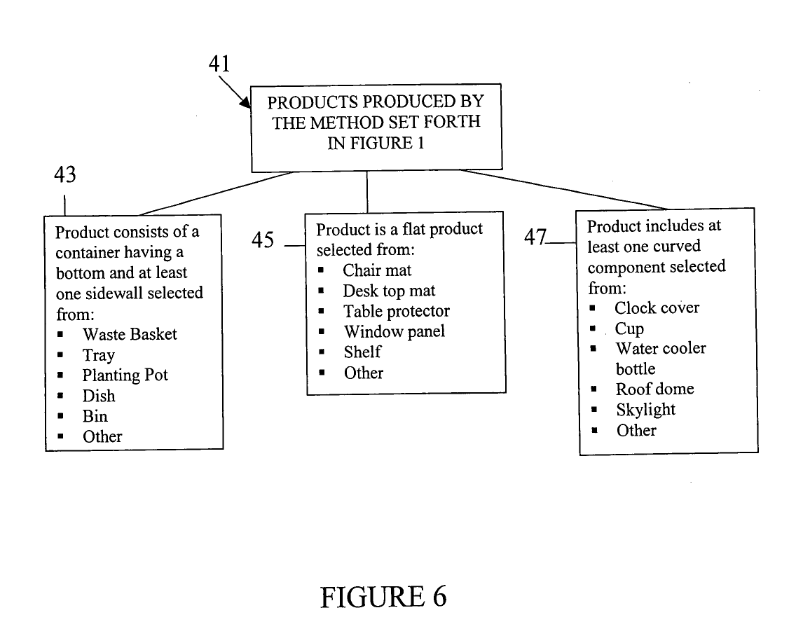

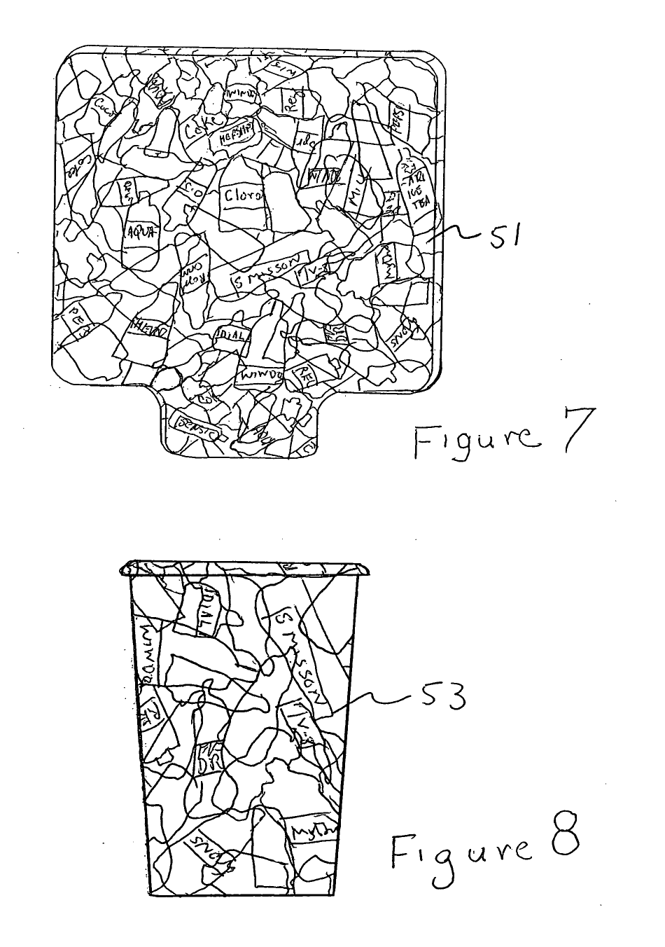

FIG. 7 illustrates a top oblique view of a chair mat 51 made by the method of the present invention wherein a sheet according to the present invention method is cut or machined into the chair mat 51.

FIG. 8 illustrates a side view of a waste basket 53 made by the method of the present invention wherein a sheet according to the present invention method is compression molded into the waste basket 53;

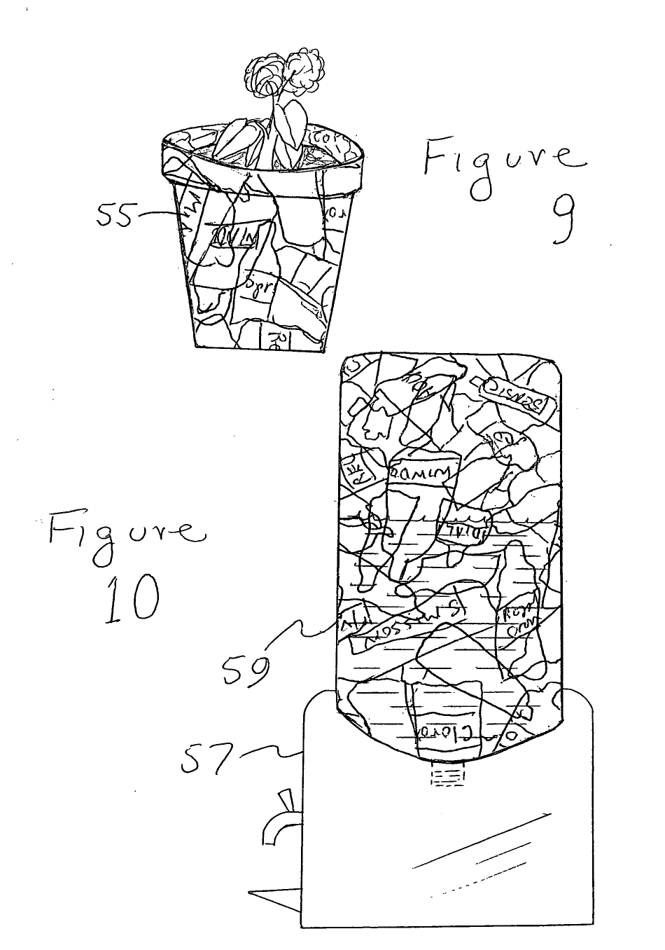

FIG. 9 illustrates a side oblique view of a plant pot 55 made by the method of the present invention wherein a sheet according to the present invention method is molded into the pot 55.

FIG. 10 illustrates a front view of a water cooler 57 with a bottle 59 made by the method of the present invention wherein a sheet according to the present invention method is blow molded as a single piece or is compression molded in two parts and heat welded into the present invention bottle 59.

Although particular embodiments of the invention have been described in detail herein with reference to the accompanying drawings, it is to be understood that the invention is not limited to those particular embodiments, and that various changes and modifications may be effected therein by one skilled in the art without departing from the scope or spirit of the invention as defined in the appended claims.

What is claimed is:

1. A method of producing a composite recycled bottle sheet product, which comprises:
(a) providing a plurality of empty, cleaned, recycled plastic bottles;
(b) stacking said bottles in a molding member having a predetermined width, said stacking having an uncompressed height of at least six inches;
(c) compressing and heating said bottles to partially melt and fuse said bottles to create a compressed flat composite recycled bottle sheet so as to visibly display a plurality of deformed identifiable bottles; and,
(d) creating a product from said compressed flat composite recycled bottle sheet so as to retain the visible display of said plurality of deformed identifiable bottles.

2. The method of producing a composite recycled bottle sheet product of claim 1 wherein said step (d) includes a processing step selected from the group consisting of molding, casting, cutting, machining, and combinations thereof.

3. The method of producing a composite recycled bottle sheet product of claim 1 wherein said heating is at a temperature of at least the lowest melting point of said bottles and exposure time is sufficient to deform, partially melt and fuse said bottles.

4. The method of producing a composite recycled bottle sheet product of claim 1 wherein said stacking has a height of at least eight inches prior to compressing and heating.

5. The method of producing a composite recycled bottle sheet product of claim 1 wherein said method is a continuous method.

6. The method of producing a composite recycled bottle sheet product of claim 5 wherein said compressing is performed utilizing at least one compression roller.

7. The method of producing a composite recycled bottle sheet product of claim 6 wherein said at least one compression roller is selected from the group consisting of a heated patterned compression roller, a cold patterned compression roller, a heated smooth compression roller, a cold smooth compression roller, and combinations thereof.

8. The method of producing a composite recycled bottle sheet product of claim 6 wherein there is one compression roller and heating is performed at time intervals selected from the group consisting of before, during, or after compression.

9. The method of producing a composite recycled bottle sheet product of claim 6 wherein there are two compression rollers and heating is performed at time intervals selected from the group consisting of before first roller compression, during first roller compression, after first roller compression, before second roller compression, during second roller compression, and after second roller compression.

10. The method of producing a composite recycled bottle sheet product of claim 5 wherein said heating is performed utilizing a method selected from the group consisting of convection, induction, microwave, ultrasonic and infrared.

11. The method of producing a composite recycled bottle sheet product of claim 10 wherein said stacking has a height of at least eight inches prior to compressing and heating.

12. The method of producing a composite recycled bottle sheet product of claim 11 wherein said stacking has a height of at least eight inches prior to compressing and heating.

13. The method of producing a composite recycled bottle sheet product of claim 12 wherein said heating is to a temperature sufficient to deform, partially melt and fuse said bottles.

14. The method of producing a composite recycled bottle sheet product of claim 12 wherein said heating is at a temperature of at least the lowest melting point of said bottles and exposure time is sufficient to deform, partially melt and fuse said bottles.

15. The method of producing a composite recycled bottle sheet product of claim 1 wherein said heating is performed utilizing a method selected from the group consisting of convection, induction, microwave, ultrasonic and infrared.

16. The method of producing a composite recycled bottle sheet product of claim 1 wherein said compressed flat composite recycled bottle sheet is fixed having a predetermined fixed length dimension.

17. The method of producing a composite recycled bottle sheet product of claim 16 wherein said heating is performed utilizing a method selected from the group consisting of convection, induction, microwave, ultrasonic and infrared.

18. The method of producing a composite recycled bottle sheet product of claim 17 wherein said stacking has a height of at least eight inches prior to compressing and heating.

19. The method of producing a composite recycled bottle sheet product of claim 18 wherein said heating is to a temperature sufficient to deform, partially melt and fuse said bottles.

20. The method of producing a composite recycled bottle sheet product of claim 18 wherein said heating is at a temperature of at least the lowest melting point of said bottles and exposure time is sufficient to deform, partially melt and fuse said bottles.

21. A product produced by the method of claim 1.

22. The product produced by the method of claim 1, wherein said product is selected from the group consisting of a container having a bottom and at least one sidewall selected from the group consisting of a waste basket, a tray, a planting pot, a dish and a bin.

23. A product produced by the method of claim 1, wherein said product is a flat product selected from the group consisting of a chair mat, a desk top mat, a table protector, a window panel, and a shelf.

24. A product produced by the method of claim 1, wherein said product includes at least one curved component.
